(19) United States
(12) Patent Application Publication
(10) Pub. No.: US 2025/0013858 A1
(43) Pub. Date: Jan. 9, 2025

(54) METHODS, APPARATUS AND COMPUTER-READABLE MEDIA RELATED TO DATA TRANSMISSION IN A NEURAL NETWORK

(71) Applicant: Telefonaktiebolaget LM Ericsson (publ), Stockholm (SE)

(72) Inventors: András VERES, Budapest (HU); András RÁCZ, Budapest (HU); Tamas BORSOS, Budapest (HU); Stefan PARKVALL, Bromma (SE); Robert BALDEMAIR, Solna (SE)

(21) Appl. No.: 18/706,456

(22) PCT Filed: Nov. 3, 2021
(86) PCT No.: PCT/SE2021/051098

§ 371 Date: May 1, 2024

(51) Int. Cl. G06N 3/049

(52) U.S. Cl. CPC G06N 3/049

(57) ABSTRACT

A method, performed by a transmitting node of a neural network, is provided for congestion level control. The method includes: sending, to a receiving node of the neural network, a plurality of sequences of data, the sequences of data being temporally encoded according to an encoding configuration; sending, to the receiving node, an indication of the encoding configuration, enabling the sequences of data to be decoded; receiving, from the receiving node, feedback including an indication of an error experienced in decoding the sequences of data; and adapting the encoding configuration based on the feedback.

### TECHNICAL FIELD

Embodiments of the present disclosure relate to neural networks, and particularly to methods, apparatus and computer-readable media for data transmission in a neural network.

### BACKGROUND

One important trend that is expected to continue and be expanded upon during the 6G research timeframe is Artificial Intelligence (AI) applications, sensors, and agents communicating information between neurons or layers of neural networks. One particularly demanding and novel application type is neuromorphic application and data in spiking neural networks (SNNs). These neuromorphic systems are often considered the third generation of AI. Neuromorphic systems include SNNs as well as more generic neuromorphic computation, which does not necessarily include artificial intelligence and learning capabilities. A neuromorphic system may comprise a neural network.

Neuromorphic systems and SNNs mimic the operation of biological neurons and their spike-based communication. In SNNs, all information carried between neurons of the network is represented by spikes. For example, a spike itself can be considered to be binary data, where the presence of a spike implicitly carries information. Examples of devices generating spike type data are neuromorphic or event cameras, where each pixel directly feeds corresponding neuron(s), and these neurons emit spikes when a change in light intensity exceeds a predefined threshold. Other types of sensors, such as artificial cochlea, skin, or touch sensors, directly generate spikes as output signals. Actuators, such as robotic arms, can be controlled via spike signals. There are also chips executing neuromorphic computing, as opposed to traditional arithmetic-based computing, which are suitable for processing the outputs of neuromorphic sensors.

The basic operation of a neuron in a neural network or neuromorphic system is illustrated in FIG. 1. Each spike received on any of the input synapses of the neuron (weighted with the synapse weight, wₙ) increases the voltage potential of that neuron. When the voltage potential reaches a threshold, the neuron emits an output spike. This model may be known as an integrate and fire neuron model. An SNN is a collection of many hundreds or thousands of such neurons, which are inter-connected via synapses according to the model illustrated in FIG. 1. The connections are not a full mesh and are typically localized.

Information that is to be communicated across the neural network can generally be encoded either into a rate of spikes or into timings of individual spikes (see FIG. 2). This may be referred to as spike encoding. For example, when a spike rate carries the information, a higher spike rate might represent a larger numerical number whereas a lower spike rate might represent a lower numerical number. In the case of timing-based encoding, the relative time between spikes or relative time between a spike and a reference point may carry information. For example, a large delay between spikes may indicate a larger encoded numerical value, whereas a small relative delay between spikes may indicate a smaller encoded numerical value.

A specific example of spike encoding is binary representation. With binary representation, the spiking pattern of a single neuron is considered in time intervals. If a neuron fires (at least once) during one time interval, this time interval may be represented by a first binary value (e.g., 1). If the neuron was not active, meaning it did not fire (at least once) during the time interval, this time interval may be represented by a second binary value (e.g., 0). Multiple time intervals can be reported at once. For example, a bitmap can be constructed with each bit of the bit map representing one time interval.

Another specific example of spike encoding is rate coding. With rate coding, it is not the timing of individual spikes which is encoded, but instead how often a neuron fires during a certain time interval (i.e., the spike rate). Rate coding particularly mirrors the behaviour of physiological neurons, which tend to fire more frequently in the case of a strong stimulus.

Another specific example of spike encoding is latency encoding. When an event is registered, a neuron tends to fire multiple times (e.g., fires a spike train) instead of just once. With latency encoding, it is the latency between an event and a first spike resulting from that event that is encoded.

Another specific example of spike encoding is full temporal encoding. Full temporal encoding encodes the timing information (e.g., the latency, etc.) of all spikes. It contains the most encoded information as compared to the previously described encoding schemes, but requires the most demanding transmission quality of service (QOS).

One problem that is associated with all of these temporal encoding schemes is delay in the communication link between a transmitting node of a neural network and a receiving node of the neural network. As the information is encoded temporally (whether as a spike rate or spike timing), delay on the communication link between transmitting and receiving nodes translates to noise in the signal decoded by the receiving node. When delay jitters occur, the encoded information and values can become distorted, causing noise and inaccuracies in the neuromorphic system.

Therefore, due to the nature of neuromorphic communication and its communication features, special requirements need to be formulated for a communication network to effectively support distributed neuromorphic-based AI applications. For example, in scenarios where spiking components are wirelessly communicating to each other, the network's radio access technology should have the following capabilities: (i) low delay and low jitter to preserve the time-sensitive aspects of spike information encoding; (ii) medium access and resource allocation methods that support unpredictable, burst-like traffic patterns; (iii) both unicast and groupcast communication that effectively support dense, local, inter-neuron connectivity, as well as sparse and remote synapses; and (iv) usual loss and Block Error Rate (BLER) mitigation algorithms, such as radio retransmission or large transmission buffer sizes which may be applied only with significant limitations.

These unique properties of neural networks create a special situation regarding the communication requirements of spike data, which none of the existing access and resource sharing schemes can fulfill in an optimal way.

### SUMMARY

According to embodiments of the present disclosure, there is provided a method performed by a transmitting node of a neural network for congestion level control. The method comprises: sending, to a receiving node of the neural network, a plurality of sequences of data, wherein the sequences of data are temporally encoded according to an encoding configuration; sending, to the receiving node, an indication of the encoding configuration, enabling the sequences of data to be decoded; receiving, from the receiving node, feedback comprising an indication of an error experienced in decoding the sequences of data; and adapting the encoding configuration based on the feedback.

Apparatus and a computer-readable medium for performing the method set out above are also provided. For example, there is provided a transmitting node for a neural network. The transmitting node comprises processing circuitry and a non-transitory computer-readable medium storing instructions which, when executed by the processing circuitry, cause the transmitting node to: send, to a receiving node of the neural network, a plurality of sequences of data, wherein the sequences of data are temporally encoded according to an encoding configuration; send, to the receiving node, an indication of the encoding configuration, enabling the sequences of data to be decoded; receive, from the receiving node, feedback comprising an indication of an error experienced in decoding the sequences of data; and adapt the encoding configuration based on the feedback.

A second aspect of the disclosure provides a method performed by a receiving node of a neural network for congestion level control. The method comprises: receiving, from a transmitting node of a neural network and, a plurality of sequences of data, wherein the sequences of data are temporally encoded according to an encoding configuration; receiving, from the transmitting node, an indication of the encoding configuration; decoding the sequences of data using the indication of the encoding configuration to obtain decoded data values for the sequences of data; and sending, to the transmitting node, feedback comprising an indication of an error associated with the decoding of the sequences of data.

Apparatus and a computer-readable medium for performing the method set out above are also provided. For example, there is provided a receiving node for a neural network. The receiving node comprises processing circuitry and a non-transitory computer-readable medium storing instructions which, when executed by the processing circuitry, cause the receiving node to: receive, from a transmitting node of a neural network and, a plurality of sequences of data, wherein the sequences of data are temporally encoded according to an encoding configuration; receive, from the transmitting node, an indication of the encoding configuration; decode the sequences of data using the indication of the encoding configuration to obtain decoded data values for the sequences of data; and send, to the transmitting node, feedback comprising an indication of an error associated with the decoding of the sequences of data.

Embodiments of the disclosure thus provide methods and apparatus which provide for adaptation of temporally encoded sequences of data so as to reduce a rate of data transmission and mitigation errors due to congestion.

### BRIEF DESCRIPTION OF THE DRAWINGS

For a better understanding of examples of the present disclosure, and to show more clearly how the examples may be carried into effect, reference will now be made, by way of example only, to the following drawings in which:

FIG. 1 is a schematic diagram showing the operation of a neuron in a spiking neural network;

FIG. 2 shows two alternative methods of temporal encoding;

FIG. 3 shows a system according to embodiments of the disclosure;

FIG. 4 is a flowchart of a method in a transmitting node according to embodiments of the disclosure;

FIG. 5 is a flowchart of a method in a receiving node according to embodiments of the disclosure;

FIG. 6 is a schematic diagram showing inhibited transmission of data according to embodiments of the disclosure;

FIG. 7 is a schematic diagram showing an error feedback mechanism according to embodiments of the disclosure;

FIG. 8 shows a transmitting node according to embodiments of the disclosure; and

FIG. 9 shows a receiving node according to embodiments of the disclosure.

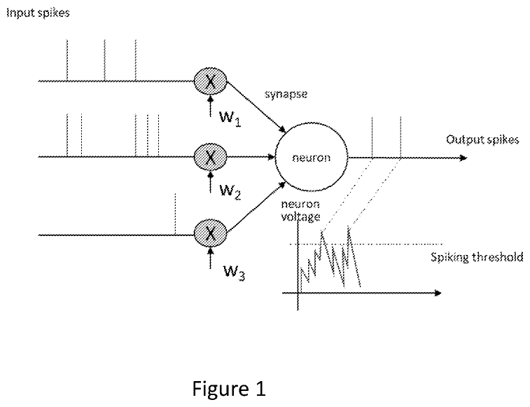

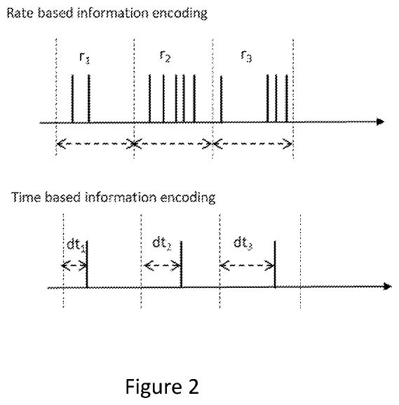

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

As noted above, neuromorphic systems such as spiking neural networks (SNNs) typically encode information temporally. That is, the information transmitted between nodes of the systems is encoded in the time dimension. The information may be encoded in the timing of the signals or spikes (e.g., with respect to each other, or some fixed reference), or in the rate of the signals or spikes. One problem that arises in this context is that fluctuations in the delay or latency of transmissions between nodes of the system has a material impact on the data itself.

In particular, where the channel between nodes of the system is subject to congestion, the latency of transmissions over that channel can increase or fluctuate. In general, all communication channels have a finite bandwidth and are therefore susceptible to congestion when the traffic demands for the channel exceed that bandwidth. Most channels will be configured with a mechanism to manage access to the channel; however, this usually comes at the cost of increased latency. Data to be transmitted over a congested channel may be stored in one or more queues or buffers until there is sufficient available bandwidth for the data to be transmitted.

For example, a radio channel in licensed spectrum may become congested owing to the finite availability of resources (e.g., transmission frequencies) and the competing requests of wireless devices to utilize those resources. Devices must wait to be scheduled sufficient resources on which to transmit their data. A radio channel in unlicensed spectrum may be congested as different wireless devices compete for access to the channel. “Listen before talk” failures, where a wireless device senses that the channel is busy before transmitting, will result in increased delay to the transmissions of that device. Optical and/or electrical wired channels may implement one or more transport protocols (e.g., Transmission Control Protocol, etc) which utilize congestion avoidance mechanisms at the cost of increased latency.

This change in latency alters the timing of signals between the nodes. Therefore, as the information is encoded temporally, the information that may be decoded by the receiving node is also altered. In other words, fluctuations in the latency result directly or indirectly in the addition of noise to the decoded information. Embodiments of the present disclosure seek to address these and other problems.

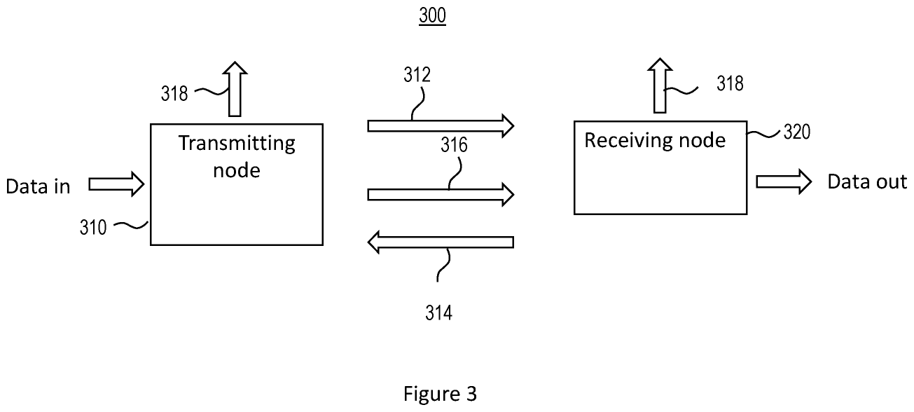

FIG. 3 shows a system 300 according to embodiments of the disclosure. The system 300 comprises a transmitting node 310 and a receiving node 320. The nodes 310, 320 belong to a neural network, and in certain embodiments the neural network is a neuromorphic network such as a spiking neural network. Data transmitted from the transmitting node 310 to the receiving node 320 comprises a plurality of sequences of data. For example, each sequence of data may comprise or correspond to the output of one or more first neurons of the neural network, which first neurons may be comprised within or communicatively coupled to the transmitting node 310. In one embodiment, the data may comprise the output of many neurons, e.g., hundreds of neurons. The data is to be provided as input to one or more second neurons of the neural network, which may be comprised within or communicatively coupled to the receiving node 320. In the illustrated embodiment, the outputs of the one or more first neurons are received by the transmitting node 310 for onward transmission to the receiving node 320, i.e., the first neurons are not co-located with the transmitting node 310.

The data is temporally encoded, i.e., outputs by the one or more first neurons are configured such that information is encoded in the temporal dimension. This temporal encoding may take one of several different forms, discussed below.

The data is transmitted from the transmitting node 310 to the receiving node 320 over a data communication channel 312 which, as noted above, may use any suitable transmission medium. In certain embodiments, the transmission medium comprises any of: radio (e.g., licensed or unlicensed spectrum); optical (e.g., free space optics or fibre optics); or electronic (e.g., wired) communication. Also as noted above, the communication channel 312 is subject to congestion which adds latency to the transmissions between the transmitting node 310 and the receiving node 320. For example, the transmission medium may have a finite capacity which is insufficient to send all the data between the transmitting and receiving nodes 310, 320 at the rate at which that data is created. Alternatively, the transmission medium may be shared with other transmitting/receiving devices whose transmissions, in certain circumstances, may take priority over transmissions between the transmitting node 310 and the receiving node 320. This is a particular problem as congestion can cause the latency of transmissions between the transmitting node 310 and the receiving node 320 to vary over time, and this can introduce errors to the temporally encoded data as noted above.

To counteract this problem, embodiments of the disclosure provide for a feedback mechanism from the receiving node 320 to the transmitting node 310. The receiving node 320 attempts to decode the data which is transmitted to it over the data communication channel 312, and determines an error that is associated with that decoding. For example, where the data is encoded as one of a predefined set of permitted symbols, the receiving node 320 may determine as the error a vector symbolic distance between a received symbol and its nearest symbol in the predefined set. Alternatively, where the data is encoded as a series of scalar values, the receiving node 320 may determine an average scalar value over a long time period in order to estimate the noise (and hence error) in the received data. Further detail regarding this aspect is set out below.

The receiving node 320 transmits an indication of that error to the transmitting node 310 over a feedback communication channel 314. The feedback communication channel 314 may use the same transmission medium as the data communication channel 312 or a different transmission medium. In the former case, the feedback communication channel 314 will generally require significantly less bandwidth than the data communication channel 312, and so will not impact the congestion over the transmission medium.

Based on the indication of the error, the transmitting node 310 adapts an encoding configuration that is applied to the data transmitted over the data communication channel 312. Numerous alternative approaches to this adaption are disclosed herein and discussed in further detail below. In one embodiment, however, where the error indicated by the receiving node 320 is relatively high (e.g., at a first error value), the encoding configuration is adapted so as to output data over the data communication channel 312 at a rate which is relatively low (e.g., at a first data rate); where the error indicated by the receiving node 320 is relatively low (e.g., at a second error value lower than the first error value), the encoding configuration is adapted so as to output data over the data communication channel at a rate which is relatively high (e.g., at a second data rate which is higher than the first data rate). Thus the rate of transmission of data over the data communication channel 312 is adapted so as to reduce congestion and reduce the variation in latency that is caused by such congestion.

As noted previously, variations in the data rate of temporally encoded information can cause problems at the receiving node 320 as there is no way to determine whether those variations are the result of the underlying data, noise in the data communication channel 312, or changes in the encoding configuration. Thus, according to embodiments of the disclosure, the transmitting node 310 further transmits, to the receiving node 320, an indication of the encoding configuration over an encoding communication channel 316. The encoding communication channel 316 may use the same transmission medium as the data communication channel 312 and/or the feedback communication channel 314 or a different transmission medium. In the former case, the encoding communication channel 316 will generally require significantly less bandwidth than the data communication channel 312, and so will not impact the congestion over the transmission medium.

The receiving node 320 may thus use the indicated encoding configuration when decoding data received over the data communication channel 312 in order to recover the underlying data (and to estimate the error). Further detail regarding this aspect is provided below.

Thus the rate of transmission of temporally encoded data over a data communication channel of a neural network can be controlled via an encoding configuration so as to reduce the impact of congestion over the channel. An indication of the encoding configuration is signalled from the transmitting node 310 to the receiving node 320 to enable the receiving node to recode the underlying information from the transmitted data. However, this does not alter the fact that the rate of data transmission over the channel 312 varies with variations in the encoding configuration. Applications generating the data for transmission over the channel 312 (e.g., controlling the one or more first neurons) may continue to generate data at a constant rate, leading to backlogs or queued data waiting for transmission over the channel. Applications using the data received over the channel 312 (e.g., controlling the one or more second neurons) may continue to expect data at the constant rate, leading to malfunctions in the second nodes and/or the neural network as a whole. To counteract this problem, according to embodiments of the disclosure, the transmitting node 310 and/or the receiving node 320 provide control signals 318 to the applications controlling the first and/or second neurons, enabling those applications to adapt the rate of data generation (e.g., in the first neurons) or to adapt the handling of data (e.g., by the second neurons). For example, the control signals may comprise an indication of the data transmission rate over the data communication channel 312. Based on that indication, the applications can control the first and/or second neurons to handle data at a rate which matches or corresponds to the rate of data transmission over the data communication channel 312. In this way, if the data communication channel 312 experiences congestion (for example), and the encoding configuration is adapted to reduce the rate of data transmission over the data channel 312, the applications controlling the first and/or second neurons can similarly adapt their operation so as to produce data at a lower rate (in the case of the first neurons) and to expect data at a lower rate (in the case of the second neurons).

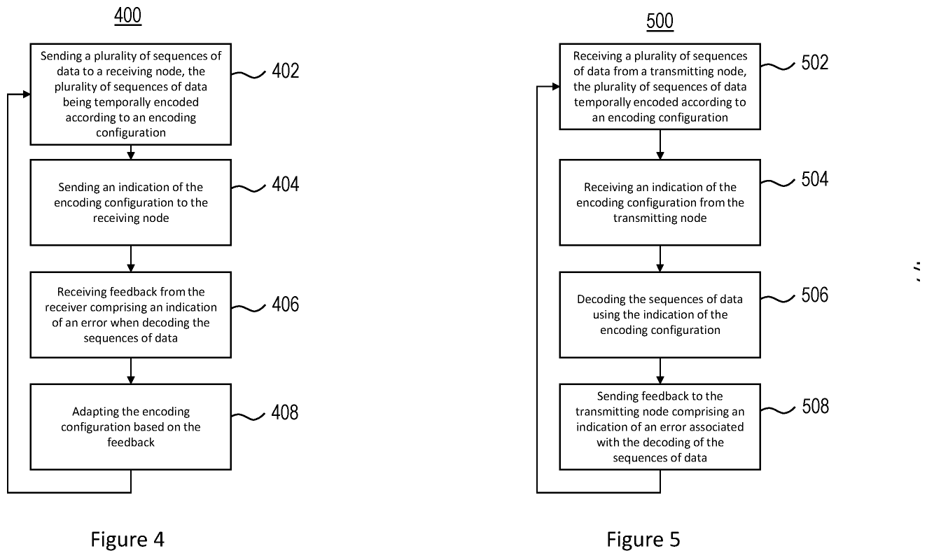

FIG. 4 is a flowchart of a method 400 in a transmitting node of a neural network according to embodiments of the disclosure. The transmitting node may correspond, in some embodiments, to the transmitting node 310 described above with respect to FIG. 3.

The method begins in step 402, in which the transmitting node sends a plurality of sequences of data to a receiving node of the neural network. The plurality of sequences of data are temporally encoded according to an encoding configuration.

Each sequence of data may correspond to the output of one or more first neurons or the neural network which are comprised within or communicatively coupled to the transmitting node. In particular embodiments, each sequence of data may comprise a sequence of spikes (e.g., where the neural network comprises a spiking neural network).

The data is temporally encoded and thus information is carried in the time dimension. As noted above, two possible ways in which information can be encoded in this way are to encode information in the rate of spikes, or in the delay, latency or timing of individual spikes or groups of spikes.

In the first example, the information may be encoded as a rate at which the one or more first neurons are firing or spiking (e.g., an average rate over a defined window of time). For example, a higher spike rate might represent a larger numerical number whereas a lower spike rate might represent a lower numerical number.

Thus the data transmitted by the transmitting node to the receiving node may comprise indications of the spiking or firing rate of the one or more first neurons. For example, the indication may comprise the spiking rate itself, or a quantized representation thereof. In the latter case, the spiking rate may be quantized with any granularity as required by the application. In one example, the spiking rate may be quantized to a single bit, i.e., “1” if the spiking rate is above a threshold, and “0” if the spiking rate is below the threshold.

Alternatively, the information may be encoded based on the timing of individual or groups of spikes, e.g., with respect to some fixed reference time or each other. For example, a large delay between spikes or groups of spikes may indicate a larger encoded numerical value, whereas a smaller relative delay may indicate a smaller encoded numerical value (or vice versa).

Thus the data transmitted from the transmitting node may comprise indications of the timing of individual spikes or groups of spikes output by the one or more first neurons. For example, the indication may comprise a binary representation, in which each bit in the sequence represents a time interval of the output of a first neuron and wherein the bit is set or asserted (e.g., “1”) if the first neuron fired or output a spike in that time interval. Multiple time intervals can be reported at once. For example, a bitmap can be constructed with each bit of the bit map representing one time interval.

In another example, the indication may comprise the latency between spikes or groups of spikes (e.g., a spike train), or between an event or reference time and the spikes or groups of spikes. When an event is registered, a neuron tends to fire multiple times (e.g., fires a spike train) instead of just once. In such examples, it is the latency between the event and, for example, a first spike resulting from that event that may be encoded.

In a further example, the indication may comprise full temporal encoding, e.g., the timing information of each individual spike output by the one or more first neurons. This information may correspond in some instances to the binary representation discussed above, but where the time interval for each bit is set appropriately short that each bit can correspond only to a single spike.

Whichever encoding method is used (e.g., timing or rate), the transmitting node transmits data to the receiving node at a data rate which is determined by the encoding configuration. The transmitting node receives data (e.g., from the one or more first neurons) at a first rate, and transmits data to the receiving node at a second rate determined by the encoding configuration. The second rate is either the same as, or lower than the first rate. Thus the encoding configuration either has no effect on the rate of data transmission, or it reduces the rate of data transmission, e.g., in response to a determination that the data communication channel between the transmitting node and the receiving node has become congested. Those skilled in the art will appreciate that there are numerous methods for reducing the rate of data transmission over a communication channel. Examples of possible methods are set out in further detail below. Note that the same encoding configuration may be applied to all sequences of data transmitted by the transmitting node, or different encoding configurations may be applied to the plurality of sequences of data. One or more sequences of data may be subject to an encoding configuration which reduces the data rate, while other sequences of data may be subject to an encoding configuration which does not reduce the data rate.

According to one embodiment of the disclosure, the transmitting node reduces the data rate of transmission by inhibiting the transmission of data (e.g., spikes) to the receiving node during one or more inhibition windows in order to reduce the data rate. The inhibition windows may occur periodically. During inhibition windows, data may be discarded for one or more sequences (or all sequences) by the transmitting node without transmission to the receiving node. Alternatively, the one or more first neurons may be controlled to inhibit their output during the inhibition windows. Outside inhibition windows, data may be transmitted to the receiving node as normal.

Inhibition may be implements in several ways. In one embodiment, the transmitting node may comprise or be coupled to a neural oscillatory circuit (implemented using, for example, recurrent networks). The oscillatory circuit may output one or more inhibitory signals periodically to the one or more first neurons inhibiting the output of those first neurons. The periodicity of the inhibitory signals may be adapted to control the periodicity of the inhibition windows. Similarly, the length of time that the inhibitory signals are produced and/or the reaction of the first neurons to those inhibitory signals may be adapted so as to control the duration of the inhibition windows. The periodicity and/or duration of the inhibition windows may be adapted so as to control the proportion of time that the output of the first neurons is inhibited (i.e., muted) and thus control the rate of data transmission by the transmitting node.

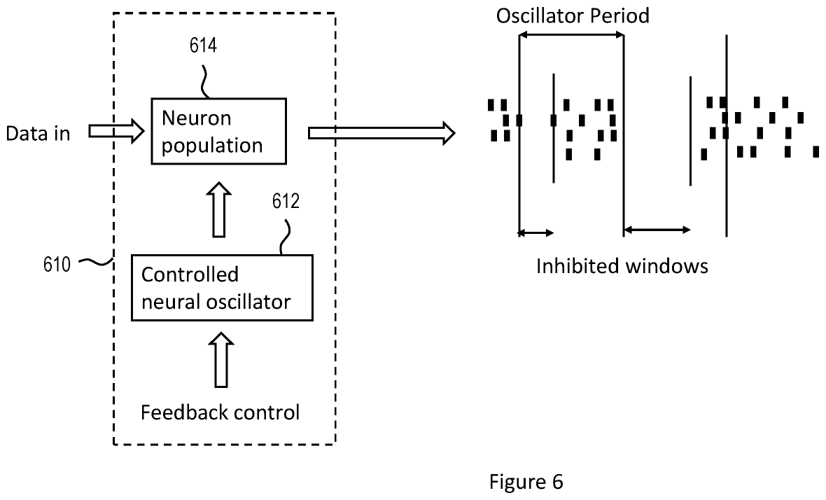

Further information regarding this embodiment is set out below with respect to FIG. 6.

In an alternative embodiment, the data is transcoded to a lower data rate prior to transmission. That is, data (e.g., spikes) output by the one or more first neurons and arriving at the transmitting node is transcoded to a lower rate prior to transmission from the transmitting node to the receiving node. According to these embodiments, the relative spiking rate between different sequences of data remains intact, but the average spiking rate is modified. That is, the spiking rate of a first sequence over time may be n(t) and the spiking rate of a second sequence over time may be m(t). The relative spiking rate of these sequences is therefore n(t)/m(t). Rate transcoding may be applied to both sequences of data to reduce the spiking rate by a factor α. Thus the data rates for the first and second sequence become an(t) and am(t) respectively, and less data is transmitted from the transmitting node to the receiving node. The relative spiking rate remains the same, however, at n(t)/m(t).

Rate transcoding may be implemented in several ways, and the present disclosure is not limited in that respect. One particularly simple method is to introduce a rate multiplier which reduces the spiking rate of each data neuron by the factor α. Thus a rate multiplier in the transmitting node receives the sequences of data from the first neurons, calculates the rate of spiking in each sequence, and multiplies those rates of spiking by α, where 0<α≤1.

An alternative method is to apply the sequences of data to a neural ensemble (e.g., a neural network) which has a tuning curve adapted to lower the spiking rate. Those skilled in the art will appreciate that the tuning curve of a neural ensemble illustrates the variation of output over a range of inputs. The tuning curve of the neural ensemble can be adapted so as transcode input spiking rates (i.e., the output of the one or more first neurons) to lower output spiking rates.

One advantage of transcoding to a lower data rate is that the logic in the transmitting node (and also the receiving node, see FIG. 5) is easy to implement. However, because the rate of transmission is lower, the effective speed of communication is reduced meaning that information will take longer to transmit at the same error level. However, slower transmission may be acceptable for particular applications, e.g., where a rapid response from the neural network is not required.

A further alternative method to reduce the rate of data transmission between the transmitting node and the receiving node is to limit the output of the one or more first neurons. For example, the transmitted spiking rate for a sequence may be capped at a maximum value even if the underlying spiking rate of the sequence (e.g., as output by the one or more first neurons) is higher than that maximum value. That is, a rate limiter is applied to each sequence of data to limit the data rate to the maximum value.

In one embodiment, such rate limiting can be implemented by applying the output of the one or more first neurons to a neural ensemble (e.g., in the transmitting node) that has a neuron ensemble with a larger refractory period than the one or more first neurons. That is, the refractory period of a neuron or a collection of neurons is the amount of time that follows a first spike before the neuron or neurons is able to spike for a second time. By applying the output of the first neurons to a neural ensemble having a higher refractory period, the minimum time period between spikes is increased, and this translates to a maximum spiking rate.

The advantage of this embodiment is that it is very simple to implement. Limiting the data rate does have the effect of introducing error (noise) to the signal. However, the applications utilizing the data will be informed that the data rates have been limited and that error is therefore likely to be higher. Higher error rates may be acceptable in a wide range of applications, especially when actions can be taken at the application level to mitigate the effects of those errors (e.g., by collecting data for a longer period of time, by reducing the weight given to data received while error rates are high, etc).

In step 404, the transmitting node transmits an indication of the encoding configuration to the receiving node, enabling the receiving node to decode the information transmitted in step 402, and particularly enabling the receiving node to account for the encoding configuration that may have been applied to reduce the data rate.

For example, where the encoding configuration comprised the application of inhibition windows, the indication of the encoding configuration may comprise one or more of: an indication of the starting time of the inhibition window (e.g., relative to a reference time); an indication of the duration of the inhibition windows; and an indication of the periodicity of the inhibition windows. Thus the receiving node can ignore or discard parts of the sequences of data corresponding to inhibition windows. These parts of the sequences of data will necessarily be absent from spikes. However, the absence of spikes does not, in itself, comprise information and can therefore be ignored.

Where the encoding configuration comprises transcoded data rates, the indication of the encoding configuration may comprise an indication of the parameter a, by which the data rates have been adapted (e.g., in a rate multiplier). Thus the receiving node is enabled to implement its own rate multiplier and apply the inverse of a to recover the original sequence of data. Alternatively, the indication of the encoding configuration may comprise an indication of the tuning curve applied in a neural ensemble, such that the inverse of the tuning curve can be applied in a corresponding neural ensemble in the receiving node and the original sequence of data recovered.

Where the encoding configuration comprises a rate limit, the indication of the encoding configuration may comprise an indication of the maximum rate, or an indication that a maximum rate has been applied to the sequence of data. While this may not permit recovery of the original sequence of data (as limiting the data rate will necessarily result in lost information), it may allow the receiving node to account for the fact that the data will have a higher error rate.

As noted above with respect to FIG. 3, the indication of the encoding configuration may be sent on the same or different transmission medium as the sequences of data. In the former case, it will be understood that the indication of the encoding configuration occupies a much smaller bandwidth than the sequences of data themselves, and is therefore unlikely to suffer from significant congestion or add to the problem of congestion over the transmission medium.

The receiving node receives the transmitted sequences of data, and uses the indication of the encoding configuration to attempt to decode the data. As will be described in greater detail with respect to FIG. 5, the receiving node also estimates the error associated with that decoded data (i.e., the difference between the sequences of data as transmitted by the transmitting node and as received by the receiving node).

In step 406, the transmitting node receives, from the receiving node, an indication of the error associated with decoding of the transmitted sequences of data. As with the indication of the encoding configuration, the error may be received over the same or a different transmission medium as the sequences of data. In the former case, it will be understood that the indication of the error occupies a much smaller bandwidth than the sequences of data themselves, and is therefore unlikely to suffer from significant congestion or add to the problem of congestion over the transmission medium.

In step 408, the transmitting node adapts the encoding configuration based on the error received in step 406. For example, where the indicated error is relatively high (e.g., due to congestion), the transmitting node may adapt the encoding configuration to transmit sequences of data at a relatively low data rate; where the indicated error is relatively low, the transmitting node may adapt the encoding configuration to transmit sequences of data at a relatively high data rate. Indications of the error may be received periodically from the receiving node such that, when the error increases from one reporting period to the next, the encoding configuration may be adapted to reduce the data rate; conversely, when the error decreases from one reporting period to the next, the encoding configuration may be adapted to increase the data rate.

It will be apparent to those skilled in the art how the data rate can be effectively altered based on the methods described above. For example, where inhibitions windows are used to alter the data rate, the periodicity and/or duration of the inhibition windows may be increased to reduce the data rate. Where the data rates are transcoded prior to transmission, the factor α may be reduced, or the tuning curves altered so as to produce lower data rates for given input data rates. Where the data rates are capped, the maximum data rate may be lowered (e.g., the refractory period increased).

The transmitting node may also send an indication of the encoding configuration (and/or other parameters indicative of the rate of data transmission to the receiving node) to an application controlling operation of the one or more first neurons (e.g., in step 404). This information enables the application to adapt the rate of data production by the one or more first neurons to reduce or prevent build-up of un-transmitted data. Thus, where the indicated rate of data transmission is lower than the rate at which the first neuron(s) are producing data, the operation of those neurons may be altered so as to reduce the rate of data production.

With this, the method 400 returns to step 402 and the new, adapted encoding configuration is used for transmitting sequences of data to the receiving node. In this way, the transmitting and receiving nodes are able to adapt their operation continually to account for congestion in the transmission medium between them.

FIG. 5 is a flowchart of a method 500 in a receiving node of a neural network according to embodiments of the disclosure. The receiving node may correspond, in some embodiments, to the receiving node 320 described above with respect to FIG. 3. The method may also complement the method 400 described above with respect to FIG. 4.

The method begins in step 502, in which the receiving node receives a plurality of sequences of data from a transmitting node of the neural network. The plurality of sequences of data are temporally encoded according to an encoding configuration.

Each sequence of data may correspond to the output of one or more first neurons or the neural network which are comprised within or communicatively coupled to the transmitting node. In particular embodiments, each sequence of data may comprise a sequence of spikes (e.g., where the neural network comprises a spiking neural network).

The data is temporally encoded and thus information is carried in the time dimension. As noted above, two possible ways in which information can be encoded in this way are to encode information in the rate of spikes, or in the delay, latency or timing of individual spikes or groups of spikes.

In the first example, the information may be encoded as a rate at which the one or more first neurons are firing or spiking (e.g., an average rate over a defined window of time). For example, a higher spike rate might represent a larger numerical number whereas a lower spike rate might represent a lower numerical number.

Thus the data transmitted by the transmitting node to the receiving node may comprise indications of the spiking or firing rate of the one or more first neurons. For example, the indication may comprise the spiking rate itself, or a quantized representation thereof.

Alternatively, the information may be encoded based on the timing of individual or groups of spikes, e.g., with respect to some fixed reference time or each other. For example, a large delay between spikes or groups of spikes may indicate a larger encoded numerical value, whereas a smaller relative delay may indicate a smaller encoded numerical value (or vice versa). Numerous formats are discussed above for encoding such timing information.

Whichever encoding method is used (e.g., timing or rate), the receiving node receives data from the transmitting node at a data rate which is determined by an encoding configuration implemented at the transmitting node. That is, the transmitting node receives data (e.g., from the one or more first neurons) at a first rate, and transmits data to the receiving node at a second rate determined by the encoding configuration. The second rate is either the same as, or lower than the first rate. Those skilled in the art will appreciate that there are numerous methods for reducing the rate of data transmission over a communication channel. Examples of possible methods are set out in detail above with respect to step 402.

In step 504, the receiving node receives an indication of the encoding configuration from the transmitting node, enabling the receiving node to decode the information received in step 502, and particularly enabling the receiving node to account for the encoding configuration that may have been applied to reduce the data rate.

For example, where the encoding configuration comprised the application of inhibition windows, the indication of the encoding configuration may comprise one or more of: an indication of the starting time of the inhibition window (e.g., relative to a reference time); an indication of the duration of the inhibition windows; and an indication of the periodicity of the inhibition windows. Thus the receiving node can ignore or discard parts of the sequences of data corresponding to inhibition windows. These parts of the sequences of data will necessarily be absent from spikes. However, the absence of spikes does not, in itself, comprise information and can therefore be ignored.

Where the encoding configuration comprises transcoded data rates, the indication of the encoding configuration may comprise an indication of the parameter a, by which the data rates have been adapted (e.g., in a rate multiplier). Thus the receiving node is enabled to implement its own rate multiplier and apply the inverse of a to recover the original sequence of data. Alternatively, the indication of the encoding configuration may comprise an indication of the tuning curve applied in a neural ensemble, such that the inverse of the tuning curve can be applied in a corresponding neural ensemble in the receiving node and the original sequence of data recovered.

Where the encoding configuration comprises a rate limit, the indication of the encoding configuration may comprise an indication of the maximum rate, or an indication that a maximum rate has been applied to the sequence of data. While this may not permit recovery of the original sequence of data (as limiting the data rate will necessarily result in lost information), it may allow the receiving node to account for the fact that the data will have a higher error rate.

As noted above with respect to FIG. 3, the indication of the encoding configuration may be received on the same or different transmission medium as the sequences of data. In the former case, it will be understood that the indication of the encoding configuration occupies a much smaller bandwidth than the sequences of data themselves, and is therefore unlikely to suffer from significant congestion or add to the problem of congestion over the transmission medium.

In step 506, the receiving node uses the indication of the encoding configuration to attempt to decode the data. The receiving node also estimates the error associated with that decoded data (i.e., the difference between the sequences of data as transmitted by the transmitting node and as received by the receiving node in step 502).

As noted above, channel effects may cause spikes in the sequences of data to be lost or delayed. Both introduce a noise when the sequences of data are decoded to produce scalar values. This noise increases with increasing amounts of spike loss.

In one embodiment, the receiving node measures the noise level by averaging the decoded scalar values over a long time period. The receiving node may also measure the variance of the decoded scalar values around the average scalar value. The calculation of the average value and/or variance may be performed continuously (e.g., over a moving time window) or periodically, for example. A baseline may be determined as the minimum variance in a longer time period (i.e., longer than the period over which the average and/or variance are determined), with the difference between this baseline value and the current value being indicative of the current noise, e.g., owing to congestion over the channel.

This noise estimation may be implemented in multiple ways, including by neural circuits. One example is to use a neural ensemble or network with relatively low inherent noise, e.g., a larger number of neurons than the one or more first neurons providing the sequences of data, and using an exponential weighted recurrent circuit with a large time constant.

The inherent noise level (the noise level over a perfect channel) can be either configured by knowing the application, or can be learned by the neural network by observing the noise levels during operation and looking for low noise periods as baseline. As noted above, differences between this inherent noise level and the current noise level or variance are indicative of the error introduced by the channel (e.g., owing to congestion).

In other embodiments, the sequences of data may utilize a vector symbolic architecture, i.e., a predefined set of values (symbols) which the transmitting node may select from when transmitting to the receiving node. Thus both the transmitting node and the receiving node have a common dictionary of transmissible symbols. The receiving node calculates the vector distance of the received vector (e.g., represented by the received spike train) to the vectors in the dictionary. The size of the difference to the best match is indicative of the channel error.

In step 508, the receiving node transmits, to the transmitting node, an indication of the error associated with decoding of the transmitted sequences of data. As with the indication of the encoding configuration, the error may be transmitted over the same or a different transmission medium as the sequences of data. In the former case, it will be understood that the indication of the error occupies a much smaller bandwidth than the sequences of data themselves, and is therefore unlikely to suffer from significant congestion or add to the problem of congestion over the transmission medium.

As noted above with respect to FIG. 4, the transmitting node may then use this error to adapt it encoding configuration, for example, to reduce errors due to congestion on the transmission medium.

The receiving node may also send an indication of the encoding configuration (and/or other parameters indicative of the rate of data transmission to the receiving node) to an application controlling operation of the one or more neurons (e.g., in step 404). This information enables applications handling the data to adapt the rate at which they expect to receive data from the one or more first neurons. Thus, where the indicated rate of data transmission is lower than the rate at which one or more second neuron(s) are expecting data, the operation of those neurons may be altered so as to reduce the rate at which they expect data.

FIG. 6 is a schematic diagram showing inhibited transmission of data according to embodiments of the disclosure. This mechanism may be applied in step 402, described above, to alter the rate of data transmission from a transmitting node to a receiving node in a neural network.

The Figure illustrates a transmitting note 610, which may be similar to transmitting node 310 described above with respect to FIG. 3.

The transmitting node receives data (“Data in”) from one or more first neurons, comprising a plurality of sequences of data (or spikes). The transmitting node 610 also receives feedback information from a receiving node (not illustrated), comprising an indication of an error associated with decoding of transmitting sequences of data.

The error is provided as a control signal to a controlled neural oscillator 612, which provides periodic inhibitory signals to a neuron population 614 based on the control signal. The neuron population 614 receives the data from the one or more first neurons, and provides the same data as output except that, while the population receives an inhibitory signal from the oscillator 612, no data (spikes) are output. The oscillator is controlled based on the feedback error signal to output inhibitory signals a greater proportion of the time while the error is relatively high, and to output inhibitory signals a lesser proportion of the time while the error is relatively low. For example, the duration of the inhibition windows and/or the periodicity of the inhibition windows may be altered so as to alter the proportion of time that output of the neuron population is inhibited.

Thus the data which is output from the neuron population 614 comprises one or more windows in which no data (no spikes) are output.

The frequency of the oscillator 612 may be set so that it is significantly lower than the typical timescale of spike encoding activity over the data channel. In this way, the inhibition periods themselves should not introduce significant error in the signal (although, as the data rate is lower, it will take longer to transmit data from the transmitting node to the receiving node while achieving the same error rate).

The transmitting node also transmits an indication of the encoding configuration (not illustrated) so that the receiving node can decode the information correctly by anticipating the inhibitory periods and decoding the data channel between inhibitions only.

One advantage of this method is that the transmitting node does not need to change its encoding logic, and the adaptation can be done in a subsequent step making the application simpler.

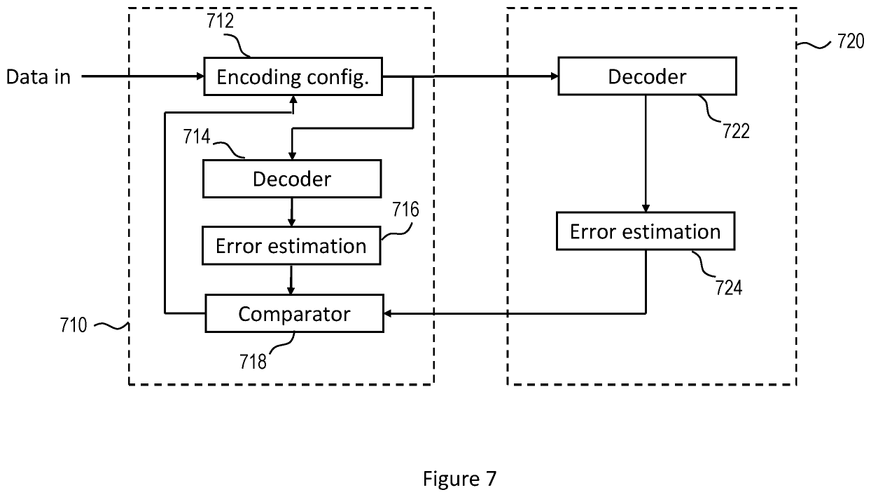

FIG. 7 is a schematic diagram showing an error feedback mechanism according to embodiments of the disclosure. This mechanism may be applied in steps 506 and 508, described above, to estimate and transmit an indication of the error when decoding temporally encoded sequences of data in a neural network.

The FIG. illustrates a transmitting node 710 and a receiving node 720, which may be similar to transmitting node 310 and receiving node 320 described above with respect to FIG. 3.

The transmitting node 710 receives data (“Data in”) from one or more first neurons. The data may comprise a plurality of sequences of data, or spikes, output from the one or more first neurons. The data is received by an encoding configuration block 712, which applies an encoding configuration to alter (e.g., reduce) the data rate of the plurality of sequences of data. These altered sequences of data are transmitted from the transmitting node to the receiving node 720.

The receiving node comprises a decoding block 722, which receives and attempts to decode the sequences of data. An error estimation block 724 estimates the error between the sequences of data as output by the one or more first neurons (“Data in”) and as received at the receiving node 720. Note that the error estimation block 724 is unable to distinguish between error introduced as a result of the transmission medium (e.g., congestion) and error introduced as a result of the encoding configuration (e.g., due to rate limiting, etc). See FIG. 5 for a fuller description of this aspect of the disclosure. The estimation block 724 outputs an indication of the error and this is transmitted as feedback to the transmitting node 710.

The altered sequences of data are also output from the encoding configuration block 712 to a second decoder 714 which is local to the transmitting node 710. The second decoder 714 also attempts to decode the sequences of data, and a second error estimation block 716 estimates the error associated with that decoding of the sequences of data. Note that the error estimated by the second error estimation block 716 will include only the possible errors introduced by the encoding configuration block 712 and not any errors associated with transmission of the sequences of data over a transmission medium (as the signals decoded by the decoder 714 have not been transmitted over any transmission medium).

A comparator 718 receives error estimates from both error estimation blocks 724, 716, and can compare the estimates to determine the error associated with the transmission medium (e.g., by subtracting one error estimate from the other). This error may then be used as a control signal to control the encoding configuration block 712 (and as described above with respect to step 408, for example).

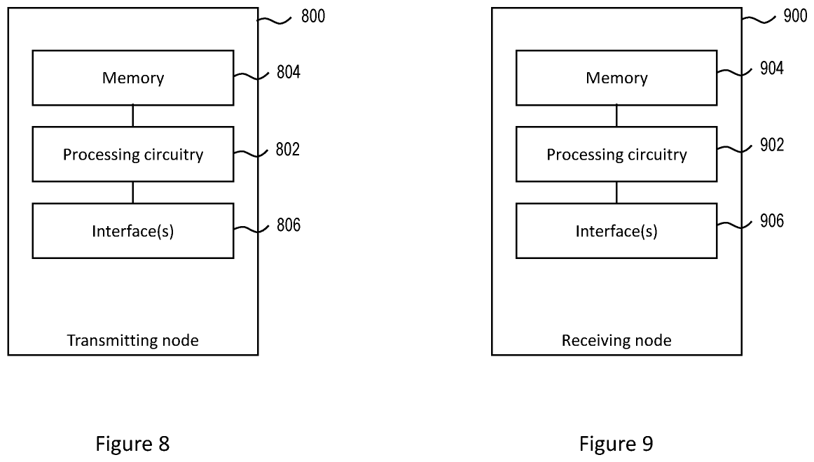

FIG. 8 illustrates a schematic block diagram of an apparatus 800 in a neural network (for example, the system 300 shown in FIG. 3). Apparatus 800 is operable to carry out the example method described with reference to FIG. 4 and possibly any other processes or methods disclosed herein. It is also to be understood that the method of FIG. 4 is not necessarily carried out solely by apparatus 800. At least some operations of the method can be performed by one or more other entities.

Apparatus 800 comprises processing circuitry 802, which may include one or more microprocessor or microcontrollers, as well as other digital hardware, which may include digital signal processors (DSPs), special-purpose digital logic, and the like. The processing circuitry 802 may be configured to execute program code stored in memory 804, which may include one or several types of memory such as read-only memory (ROM), random-access memory, cache memory, flash memory devices, optical storage devices, etc. Program code stored in memory 804 includes program instructions for executing one or more telecommunications and/or data communications protocols as well as instructions for carrying out one or more of the techniques described herein, in several embodiments. In some implementations, the processing circuitry 802 may cause the apparatus 800 to perform corresponding functions according one or more embodiments of the present disclosure.

According to embodiments of the disclosure, the processing circuitry 802 is configured to cause the apparatus 800 to: send, to a receiving node of the neural network, a plurality of sequences of data, wherein the sequences of data are temporally encoded according to an encoding configuration; send, to the receiving node, an indication of the encoding configuration, enabling the sequences of data to be decoded; receive, from the receiving node, feedback comprising an indication of an error experienced in decoding the sequences of data; and adapt the encoding configuration based on the feedback.

The apparatus 800 may be implemented in a node of a communication network, such as a radio network, an optical network, or an electronic network. Thus the apparatus 800 further comprises one or more interfaces 806 with which to communicate with one or more other nodes of the communication network (e.g., the receiving node). The interface(s) 806 may therefore comprise hardware and/or software for transmitting and/or receiving one or more of: radio signals; optical signals; and electronic signals.

In alternative embodiments, the apparatus 800 may comprise one or more units or modules configured to perform the steps of the method, for example, as illustrated in FIG. 4. In such embodiments, the apparatus 800 may comprise a sending unit, a receiving unit, and an adapting unit. The sending unit may be configured to send, to a receiving node of the neural network, a plurality of sequences of data, wherein the sequences of data are temporally encoded according to an encoding configuration; and to send, to the receiving node, an indication of the encoding configuration, enabling the sequences of data to be decoded. The receiving unit may be configured to receive, from the receiving node, feedback comprising an indication of an error experienced in decoding the sequences of data. The adapting unit may be configured to adapt the encoding configuration based on the feedback.

FIG. 9 illustrates a schematic block diagram of an apparatus 900 in a neural network (for example, the system 300 shown in FIG. 3). Apparatus 900 is operable to carry out the example method described with reference to FIG. 5 and possibly any other processes or methods disclosed herein. It is also to be understood that the method of FIG. 5 is not necessarily carried out solely by apparatus 900. At least some operations of the method can be performed by one or more other entities.

Apparatus 900 comprises processing circuitry 902, which may include one or more microprocessor or microcontrollers, as well as other digital hardware, which may include digital signal processors (DSPs), special-purpose digital logic, and the like. The processing circuitry 902 may be configured to execute program code stored in memory 904, which may include one or several types of memory such as read-only memory (ROM), random-access memory, cache memory, flash memory devices, optical storage devices, etc. Program code stored in memory 904 includes program instructions for executing one or more telecommunications and/or data communications protocols as well as instructions for carrying out one or more of the techniques described herein, in several embodiments. In some implementations, the processing circuitry 902 may cause the apparatus 900 to perform corresponding functions according one or more embodiments of the present disclosure.

According to embodiments of the disclosure, the processing circuitry 902 is configured to cause the apparatus 900 to: receive, from a transmitting node of a neural network, a plurality of sequences of data, wherein the sequences of data are temporally encoded according to an encoding configuration; receive, from the transmitting node, an indication of the encoding configuration; decode the sequences of data using the indication of the encoding configuration to obtain decoded data values for the sequences of data; and send, to the transmitting node, feedback comprising an indication of an error associated with the decoding of the sequences of data.

The apparatus 900 may be implemented in a node of a communication network, such as a radio network, an optical network, or an electronic network. Thus the apparatus 900 further comprises one or more interfaces 906 with which to communicate with one or more other nodes of the communication network (e.g., the transmitting node). The interface(s) 906 may therefore comprise hardware and/or software for transmitting and/or receiving one or more of: radio signals; optical signals; and electronic signals.

In alternative embodiments, the apparatus 900 may comprise one or more units or modules configured to perform the steps of the method, for example, as illustrated in FIG. 5. In such embodiments, the apparatus 900 may comprise a receiving unit, a decoding unit, and a sending unit. The receiving unit may be configured to receive, from a transmitting node of a neural network, a plurality of sequences of data, wherein the sequences of data are temporally encoded according to an encoding configuration; and to receive, from the transmitting node, an indication of the encoding configuration. The decoding unit may be configured to decode the sequences of data using the indication of the encoding configuration to obtain decoded data values for the sequences of data. The sending unit may be configured to send, to the transmitting node, feedback comprising an indication of an error associated with the decoding of the sequences of data.

The term “unit” may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

1. A method performed by a transmitting node of a neural network for congestion level control, the method comprising:
sending, to a receiving node of the neural network, a plurality of sequences of data, the sequences of data being temporally encoded according to an encoding configuration;
sending, to the receiving node, an indication of the encoding configuration, enabling the sequences of data to be decoded;
receiving, from the receiving node, feedback comprising an indication of an error experienced in decoding the sequences of data; and
adapting the encoding configuration based on the feedback.

2. The method of claim 1, wherein the neural network comprises a spiking neural network, and wherein the sequences of data comprise sequences of one or more spikes.

3. The method of claim 1, wherein adapting the encoding configuration comprises adapting a rate at which information is encoded temporally for transmission.

4. The method of claim 1, wherein the encoding configuration comprises an inhibition time window during which the transmitting node is prohibited from transmitting one or more of the sequences of data.

5. The method of claim 4, wherein adapting the encoding configuration comprises adapting one or more of: a duration of the inhibition time window; and a periodicity of the inhibition time window.

6. The method of claim 4, wherein the indication of the encoding configuration comprises an indication of the inhibition time window.

7. The method of claim 1, wherein adapting the encoding configuration comprises:
adapting a rate at which data is transmitted by the transmitting node, such that an absolute rate at which data is transmitted by the transmitting node is changed for two or more sequences of data, but a relative rate between the two or more sequences of data is unchanged.

8. The method of claim 7, wherein adapting the rate at which data is transmitted by the transmitting node comprises:
transcoding the sequences of data according to an adaptive tuning curve, wherein the adaptive tuning curve adapts the average rate at which data is transmitted by the transmitting node.

9.-11. (canceled)

12. The method according to claim 1, wherein adapting the encoding configuration comprises:
adapting a maximum rate at which data can be transmitted by the transmitting node.

13. The method of claim 1, wherein adapting the encoding configuration based on the feedback comprises applying a first encoding configuration when the error is a first level, and applying a second encoding configuration when the error is a second level, wherein the first level is greater than the second level, and wherein the first encoding configuration has a lower average data rate than the second encoding configuration.

14. The method of claim 1, wherein the sequences of data are sent to the receiving node using one or more of: radio transmission; optical transmission; free space visible light transmission; and electrical transmission.

15. A method performed by a receiving node of a neural network for congestion level control, the method comprising:
receiving, from a transmitting node of a neural network and, a plurality of sequences of data, the sequences of data being temporally encoded according to an encoding configuration;
receiving, from the transmitting node, an indication of the encoding configuration;
decoding the sequences of data using the indication of the encoding configuration to obtain decoded data values for the sequences of data; and
ending, to the transmitting node, feedback comprising an indication of an error associated with the decoding of the sequences of data.

16. The method of claim 15, wherein the neural network comprises a spiking neural network, and wherein the sequences of data comprise sequences of one or more spikes.

17. The method of claim 15, wherein the encoding configuration is based on the feedback, and wherein a first encoding configuration is applied when the error is a first level, and a second encoding configuration is applied when the error is a second level, wherein the first level is greater than the second level, and wherein the first encoding configuration has a lower average data rate than the second encoding configuration.

18. The method of claim 15, further comprising estimating the error, wherein the error comprises a difference between the sequences of data as received by the receiving node, and the sequences of data as transmitted by the transmitting node.

19. The method of claim 18, wherein the sequences of data comprise scalar values, and wherein estimating the error comprises averaging the scalar values over a time period.

20. The method of claim 18, wherein the sequences of data comprise sequences of data symbols selected from a predefined set of data symbols, and wherein estimating the error comprises measuring a distance between a data symbol in a received sequence of data and a nearest data symbol in the predefined set of data symbols.

21. The method of claim 15, wherein the sequences of data are received from the transmitting node using one or more of: radio transmission; optical transmission; free space visible light transmission; and electrical transmission.

22. (canceled)

23. A transmitting node for a neural network, the transmitting node comprising processing circuitry and a non-transitory computer-readable medium storing instructions which, when executed by the processing circuitry, cause the transmitting node to:
send, to a receiving node of the neural network, a plurality of sequences of data, the sequences of data being temporally encoded according to an encoding configuration;
send, to the receiving node, an indication of the encoding configuration, enabling the sequences of data to be decoded;
receive, from the receiving node, feedback comprising an indication of an error experienced in decoding the sequences of data; and
adapt the encoding configuration based on the feedback.

24.-30. (canceled)

31. A receiving node for a neural network, the receiving node comprising processing circuitry and a non-transitory computer-readable medium storing instructions which, when executed by the processing circuitry, cause the receiving node to:
receive, from a transmitting node of a neural network and, a plurality of sequences of data, the sequences of data being temporally encoded according to an encoding configuration;
receive, from the transmitting node, an indication of the encoding configuration;
decode the sequences of data using the indication of the encoding configuration to obtain decoded data values for the sequences of data; and
send, to the transmitting node, feedback comprising an indication of an error associated with the decoding of the sequences of data.

32.-38. (canceled)
